(19) United States
(12) Patent Application Publication
(10) Pub. No.: US 2008/0092059 A1
(43) Pub. Date: Apr. 17, 2008

(54) SYSTEM AND METHOD FOR ONLINE AND PROGRAMMATIC PLANNING OF EVENTS THAT ARE ATTENDED BY PERSONS

(76) Inventor: George White, Amargosa Valley, NV (US)

Correspondence Address: SHEMWELL MAHAMEDI LLP, 4880 STEVENS CREEK BOULEVARD, SUITE 201, SAN JOSE, CA, 95129, US

(21) Appl. No.: 11/865,929

(22) Filed: Oct. 2, 2007

Related U.S. Application Data
(60) Provisional application No. 60/828,210, filed on Oct. 4, 2006.

(51) Int. Cl. G06F 3/00

(52) U.S. Cl. 715/747

(57) ABSTRACT

A programmatic, online system and method by which individuals can plan an event that is to be attended by persons, enabling individuals to share event schedules, and provide information by which various other activities can be planned for the event.

### RELATED APPLICATIONS

This application claims benefit of priority to Provisional U.S. Patent Application No. 60/828,210, filed Oct. 4, 2006, entitled SYSTEM AND METHOD FOR ONLINE AND PROGRAMMATIC PLANNING OF EVENTS THAT ARE ATTENDED BY PERSONS; the aforementioned priority application being incorporated by reference in its entirety.

### TECHNICAL FIELD

Embodiments of the invention relate to systems for programmatic and online planning of events that are attended by persons.

### BACKGROUND

Planning events such as weddings, receptions, anniversary parties or other special events can be an arduous, stressful, and time consuming process. Traditionally, interested persons (such as the bride and groom) manually attend to details and plan for such events. One typical task carried out in the planning of events is the selection of vendors. For example, in a wedding, the bride and groom typically select a photographer, florist, caterer, a location, a pastor or other person to deliver vows, entertainment and numerous other vendors and service providers.

Additionally, selecting vendors during the planning of such events can be a risky affair for the interested parties. Even when vendors provide quality services, there is always the potential for a clash in style or preference For example, the style used by a particular wedding photographer may not be to the liking of the bride and groom, even when pictures taken by the photographer are of quality.

In addition to finding service providers or vendors for the event, scheduling the event and coordinating guests and vendors is arduous when performed manually. Vendors and guests often need to be coordinated in timing and location.

### BRIEF DESCRIPTION OF THE DRAWINGS

FIG. 1 is a basic block diagram of a system for enabling creation of a profile for a planned event.

FIG. 2 illustrates a method for identifying and determining aesthetic preferences for an event, according to an embodiment of the invention.

FIG. 3 illustrates a technique by which samples representative of a particular category, style and/or vendor can be presented to an event planner, under an embodiment.

FIG. 4 describes a method for updating the event profile as information becomes known to a planner in stages, according to an embodiment of the invention.

FIGS. 5A and 5B shows a sample user interface for rating samples according to an embodiment of the present invention.

FIG. 6 shows an example of the schedule dialogue, according to an embodiment of the invention.

FIG. 7 illustrates a system architecture, under one or more embodiments of the invention.

### DETAILED DESCRIPTION

Embodiments described herein provide a technique and system for electronically assisting the planning of events attended by persons. Such events may include formal and informal ceremonies, as well as business events such as corporate events and seminars. As will be described, one or more embodiments described herein provide a programmatic, online mechanism by which individuals can plan events, share event schedules, and provide information by which various other activities can be planned for the event.

As used herein, the term “event” means events attended by persons, such as celebrations and ceremonies. Examples of events include weddings and wedding receptions, corporate functions, seminars, celebrations (e.g. anniversary parties, birthday parties, holiday office parties, bar mitzvahs), formal family events (e.g. wakes, funerals) and numerous other kinds of events that require some planning or structure (family reunions, religious ceremonies, company meetings and corporate events).

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

As used herein, the term “aesthetic” refers to a particular taste or liking of the senses of a given individual.

The term “programmatically” means through the use of computer-executed instructions or code.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

Overview

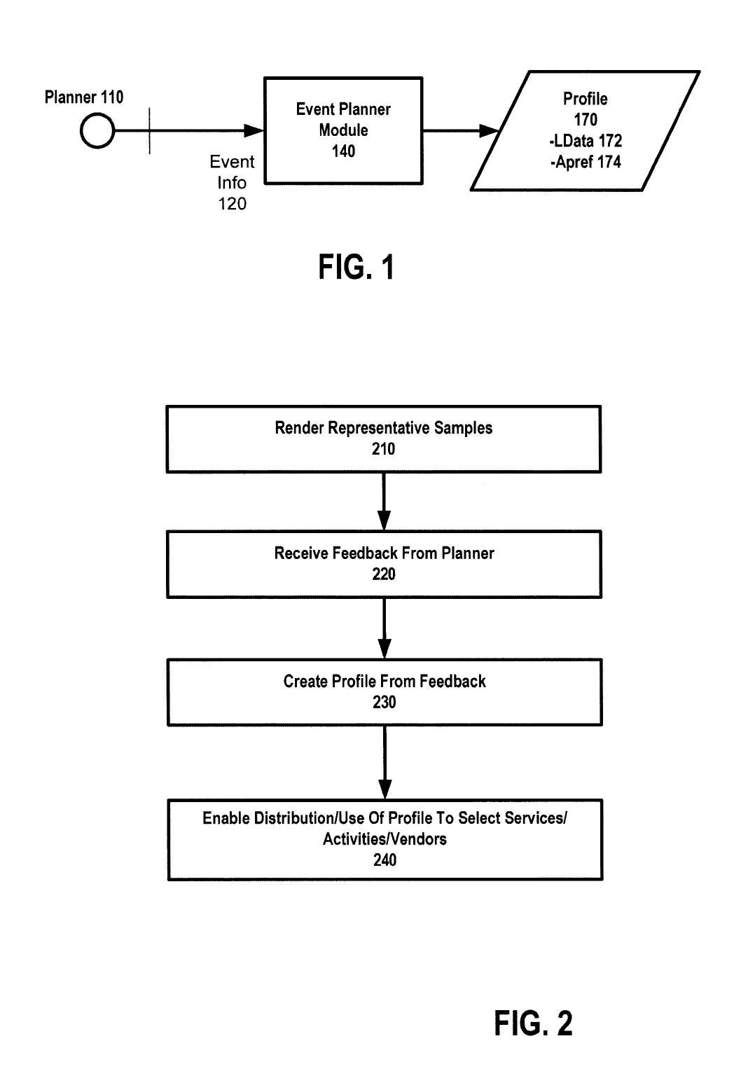

FIG. 1 is a basic block diagram of a system for enabling creation of a profile for a planned event. As described in more detail, an event profile may include information that indicates various kinds of logistic data (e.g. date, time and location of planned event) as well as information that is indicative of aesthetic preferences of the planners for the event. As will be described, an embodiment provides that the EPM 140 includes processes by which the information about the aesthetic processes is programmatically learned and analyzed. Such an embodiment enables more precise and informative determination of certain aesthetic preferences, such as when the user does not have the experience or vocabulary to specify an aesthetic preference with precision. The information indicating aesthetic preferences may be used to influence the selection of activities, services and/or vendors who provide services. In one embodiment, a combination of logistic data and aesthetic information is used to manually select vendors and services for the event. In another embodiment, individual vendors or services may be selected primarily through a programmatic process that uses the information about the aesthetic preferences, as well as possibly the logistic data.

With further reference to FIG. 1, a system includes an event planning module (EPM) 140 that inputs event information 120 from a user or planner 110. The event information 112 may include logistic data from the planner or participant, as well as data that can be used to identify or derive information about the planner's aesthetic preferences to certain activities or services that may be performed in connection with the event. As described with one or more embodiments, the information for identifying/deriving the aesthetic preferences may be in the form of quantitative feedback data the user provides to representative samples.

The EPM 140 outputs information that results in the creation of a profile 170. In one embodiment, the profile 170 aggregates logistic data 172 and information about aesthetic preferences 174 for use in subsequent planning and coordination of the event. In an embodiment shown by FIG. 1, the planner 110 operates a computing device or terminal to access and communicate with the EPM 140. The user terminal may include a web interface, such as provided by a web browser and Internet connection 144. The EPM 140 may operate on a server and be accessible at a web site.

Over the course of one or more online sessions, planner 110 submits event information 120 to the EPM 140. The event information 120 may include logistic data, such as identification of the event, the date, time and location of the event, interested parties, possible guests and various other kinds of information and details. As will be described with one or more other embodiments, the event information 120 may also include input that one or more intelligent processes of the EPM 140 uses to build the profile 170, or portions thereof. The profile 170 may be associated with the event, either directly or indirectly (e.g. associated with a planner of the event). Furthermore, as also described with one or more other embodiments, the event information 120 may be provided directly or indirectly by the user over a course of time that can extend to weeks, months or even years.

In one embodiment, profile 170 provides a comprehensive collection of various kinds of information that can subsequently be used to plan for events and/or perform various tasks related to the event. These tasks may include, for example (i) vendor selection, (ii) coordination of activities and vendors, (iii) venue selection, and (iv) theme/décor selection, and (v) various other features (cuisine, entertainment). In one embodiment, some or all of the tasks are performed programmatically. Some tasks may also be performed manually, through, for example, a human operator that uses the data to identify or recommend vendors. In order to identify, recommend, or selection potential vendors, venue or other activities, some cross-reference (performed manually or programmatically) may be needed between logistic data and aesthetic preferences. For example, a human operator may use the profile 170 to identify location, date, and time of the event. The operator may query vendors for availability at the location and date. From available vendors (as determined by the logistic data), the operators may select/recommend one or more vendors by independent investigation or research as to how well the vendor will satisfy the aesthetic preferences of the user. A vendor list may be maintained or used in the vendor selection. Alternatively, previously unknown vendors may be identified and used through traditional sources, such as yellow pages or other public directories. In one embodiment, the profile 170 enables the human operator to generate a questionnaire or identify criteria for use in selecting the vendors. Still further, some or all tasks that can be performed by the human operator may be performed by programmatic processes, running on, for example, servers that provide the EPM 140.

In one embodiment, the candidate vendors are programmatically (or manually) subjected to an iterative selection process that narrows a field of candidate vendors. Such a process may include the use of samples, user input or feedback of samples, logistic data and other criteria or factors. For example, a particular vendor from the list of candidates may be recommended or selected because the vendor provides a particular type of service, or can perform at a particular location. Still further, one or more embodiments contemplate that user input (e.g. logistic data or explicit preference or condition of the user) may filter the pool of vendors from which samples are delivered and event profile information is developed. For example, if the planner 110 is looking for a photographer for a wedding that is being conducted as a particular kind of ceremony, the user may specify experience or specialty with the particular kind of service as a criteria before viewing samples. In this way the user is able to better rate the photographer's sample as it will apply to their own wedding or other special occasion.

Methodology for Identifying Aesthetic Preferences

Events have various stylistic and aesthetic influences that typically depend on the preferences of the planners and attendees. Such influences affect theme, décor, cuisine, venue, entertainment, and various other activities and services (including vendor-provided services) associated with an event. As a specific example, a wedding photographer may be selected based on a style of photography that is preferred by the bride and groom, Similarly, floral arrangements and cuisine style may match preferences of the planner or attendees. Even venue (open air, scenic) and venue-related services are impacted by preferences, for when the services are of either a personal nature (e.g. wedding) or professional (corporate event).

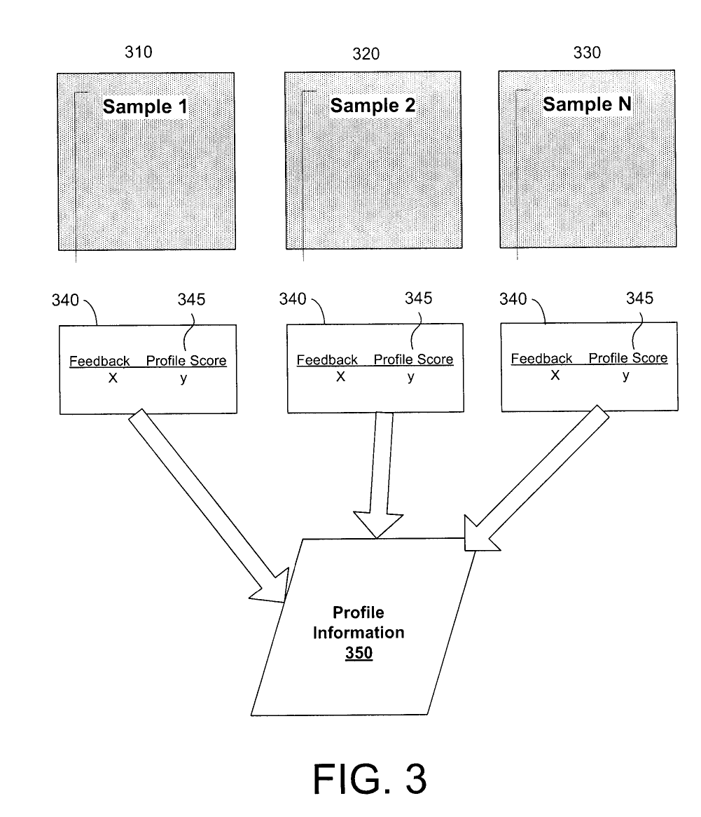

FIG. 2 illustrates a method for identifying and determining aesthetic preferences for an event, according to an embodiment of the invention. A method such as described with FIG. 2 may be used to facilitate/enable coordination, planning, selection of services and vendors. A method such as described with FIG. 2 may be implemented using components or modules described with other embodiments, including with one or more embodiments of FIG. 1. To the extent reference is made to components from other figures, such reference should be considered as only an example of a suitable component for use in performing a step or sub-step being described.

In step 210, representative samples of a service or activity or other feature of an event is rendered to the planner. In one embodiment, the rendering is over an online medium. For example, a user may, through operation of a web browser on an online connection, view sample images of a style or genre associated with an activity or vendor service. The samples may be selected based on a pre-determination that the samples are representative of a particular genre or stylistic feature. For example, in the context of wedding photographers, samples may represent posed photography, candid photography, and black and white photographs. In the context of entertainment, samples may include rendering of music that fits a particular genre or category.

In a step 220, feedback is recorded from the user in response to the rendering of the samples. In one embodiment, the feedback is quantitative, reflecting feedback corresponding to scores or ratings provided by the user. Various forms of quantitative feedback are contemplated. In one alternative embodiment, a user may be provided a plurality of samples, and asked to select which sample is most preferred. Subsequently, a more tailored set of samples are presented, and the user's subsequent selection results in an iterative selection of one or more characteristics, features and/or style preferences. Still further, other embodiments contemplate a qualitative analysis of user feedback. The user may enter as feedback a text description of a preferred theme, from which vendors, services and activities may be selected, recommended, or presented to the user. For example, the user may be asked to name a favorite movie, from which décor or theme preference may be identified.

In step 230, a profile for the event (or alternatively the planner) is created and updated based on the feedback provided for the various vendor samples. In an embodiment, the samples that are to be rendered for the user are known and pre-designated. In one embodiment, the samples represent stylistic categories or genres of a particular vendor (e.g. photographer), service, activity or characteristic (e.g. venue) of the event. With the presentation of each sample that is to be displayed, rating feedback is received from the planner. As the rendering of samples continues, the EPM 140 (or other component of the system) may record a running score for each category based on the rating scale of 1-5. The score for each particular category will be expressed as a percentage of the possible maximum score for each photograph, i.e., a percentage of rating each photograph a “5”. After each sample is presented, the event profile may be updated by the EPM 140 or the profile may be updated at the end of the online session.

For example, if the user has reviewed 10 category 1 photographs and given each one the following scores, the user's scores for category 1 photographs would be 41 out of 50, or 82%.

TABLE 1

| Photo - Category | User Ranking |
|---|---|
| P1 - Category 1 | 4 |
| P2 - Category 1 | 5 |
| P3 - Category 1 | 3 |
| P4 - Category 1 | 5 |
| P5 - Category 1 | 4 |
| P6 - Category 1 | 4 |
| P7 - Category 1 | 5 |
| P8 - Category 1 | 4 |
| P9 - Category 1 | 3 |
| P10 - Category 1 | 4 |
| Total | 82.0% |

Such data may show that the user has a strong tendency to prefer traditional or conservative types of photographs.

However, the category of photographs displayed to the user may be intermixed and need not be presented to the user based on category. For example a user may view 100 photographs, 25 from category 1, 45 from category 2 and 30 from category 3. Based on the ratings from the user, the category percentages may be as follows:

TABLE 2

| | |
|---|---|
| Category 1 - Conservative/traditional | 82% |
| Category 2 - Contemporary | 79% |
| Category 3 - Artistic/Edgy | 56% |

This data shows that the user prefers more traditional photographs but would not be opposed to receiving a more contemporary or creative photographs of the event (e.g. a wedding).

In another example the ratings of the photographs may be as follows:

TABLE 3

| | |
|---|---|
| Category 1 - Conservative/traditional | 65% |
| Category 2 - Contemporary | 91% |
| Category 3 - Artistic/Edgy | 60% |

In this case, the data would be interpreted to mean that the user has is interested in a wide range of work but the coverage of the event (e.g. wedding day) should be heavily focused on contemporary imagery.

In yet another example, the user ratings for the 100 photographs may be as follows:

TABLE 4

| | |
|---|---|
| Category 1 - Conservative/traditional | 32% |
| Category 2 - Contemporary | 75% |
| Category 3 - Artistic/Edgy | 96% |

This data shows that the user demonstrates a strong preference for creative and artistic work, and will likely be disappointed with more traditional types of photographs.

In a web-based system, every time a user logs in to the system and ranks photographs or samples, the system updates the event profile so that it reflects the user's updated preferences. However, although a web-based interface or system is contemplated, other operational environments (networked or otherwise) may be implemented for one or more embodiments described herein. The same process of rating and scoring photographs may be done manually.

For example, the person planning the event may review a number of sample wedding photographs in the presence of a professional event planner. Such a session may result in a manual rating by the person for a selected pool of samples. In step 240, the feedback is used to formulate and identify aesthetic preferences of the event. The aesthetic preferences formulate a portion of the profile, which can then be manually/programmatically to select vendors, activities and other characteristics of the event. In one embodiment, for example, the aesthetic preferences may be used to identify a general desired theme for the event. In one embodiment, operators identify vendors, activities, characteristics (e.g. décor and venue) for the event. Alternatively, programmatic processes are performed to select or recommend vendors. Alternatively, the stylistic preferences may be specific to a particular service, activity or feature of the event. For example, the stylistic preferences may identify a type of photographer that is desired for the event, independent of other aspects of the event.

As mentioned with an embodiment of FIG. 1, the aesthetic preferences may be used in connection with other information that comprises the profile to enable identification, research and/or selection of services and vendors. For example, based on a determination of a preferred genre for a photographer, a human operator may query photographers in the location of the event for availability, and communicate the preferred genre or style to photographers who are available. In one scenario, the photographer is able to conform his style to the preferences of the user, as communicated through the aesthetic preferences developed from the feedback. In another scenario, samples or other information from the vendor are used to match (manually or programmatically) an available vendor to the event. In one embodiment, the profile, with inclusion of the aesthetic preferences, is distributed and used by the planner, participants, and/or human operators for various planning and coordination activities. For example, participants may learn of a desired theme for a celebration, and dress accordingly. Human operators may know how to qualify vendors for use in the event. Logistic data contained in the profile information may synchronize all attendees. Numerous other variations, implementations, and embodiments are also contemplated.

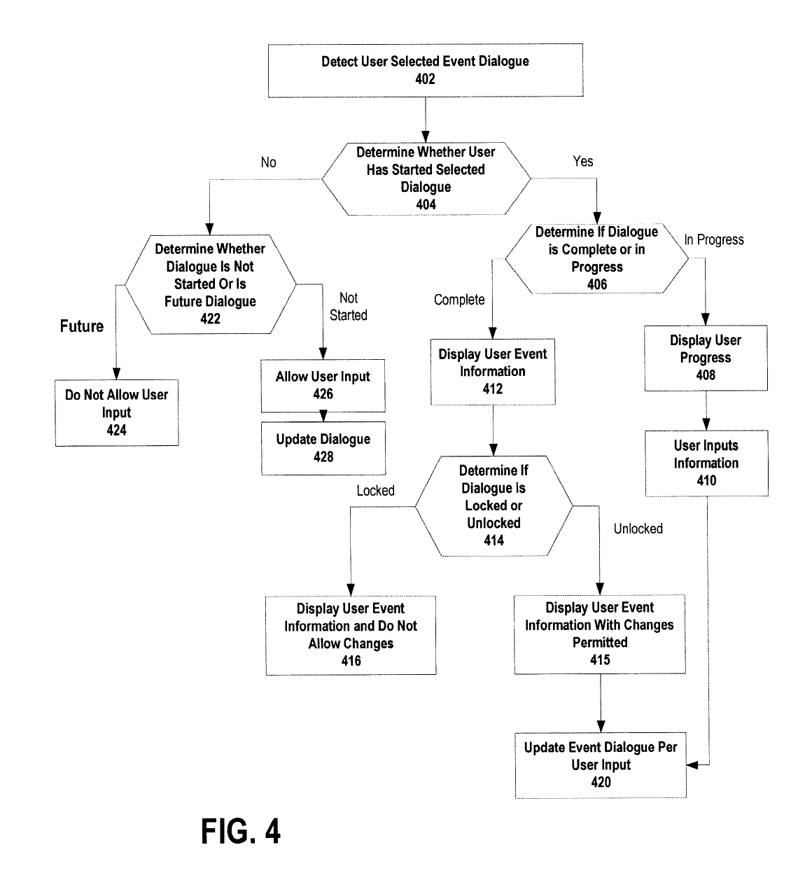

FIG. 3 illustrates a technique by which samples representative of a particular category, style and/or vendor can be presented to an event planner, under an embodiment. In an embodiment, the views images that correspond to or display representations of a particular service, feature or characteristic of an event. Any number of vendor samples may be displayed and rated, and an event profile associated with the user may be updated accordingly. For purpose of description, FIG. 3 is described in the context of wedding photography, and the representative samples are illustrative of various styles or genres of wedding photography.

In order to view the samples, the user may access a server, computer, or site (website) where a profile for the event may be maintained and updated.

Once the user accesses the site, a series of images are displayed to the user for feedback. Photo sample-1 310, photo sample-2 320, and photo sample-n 330 illustrate such a showing. The photographs may be one of many photographs that are pre-designated to represent a genre, style, hybrid, or particular feature of wedding photography. When the user views the sample photo, the user has the ability to rate the sample on a scale of 1-5 through use of a rating interface 340. With each feedback, a profile score 345 is updated or otherwise maintained. The profile score 345 may reflect a stylistic preference on a spectrum of styles that are available to the user for the particular service (e.g. wedding photography). Upon rating the sample image, the score for that image is recorded by the system, and another image relating to the event is selected and displayed to the user from the database. The process may continue until completion or termination by the user. As described with one or more other embodiments, the process may also be distributed over multiple online sessions.

As an example, one implementation of an embodiment enables a planner to select a wedding photographer. A system such as described with FIG. 1 may store and sort samples that are representative of a particular photographic style. Alternatively, the samples may represent other categories, such as price range. Still further, the samples may represent sample work products of vendors. In one user-interface dialogue, each of the samples are displayed to the user. The user provides a feedback score 340. Concurrently, an overall profile value or score 345 is maintained with each input from the user. In one implementation, with the entrance of each feedback 340, the profile value 345 is updated.

The selection of what samples to display to the user may follow a pre-set process. Thus, each planner who uses a system such as described with FIG. 1 may be displayed the same set of photographs. Other embodiments provide a more intelligent process of sample selection, where the system learns from the user's feedback and selects samples in an iterative and learned process. Other variations to how samples are displayed are also possible.

While numerous examples provided above are specific to wedding photographers, other examples described herein provide for use of other kinds of vendors, possibly for various kinds of events. For example, a process such as described with FIG. 3 may be used to enable a user to select styles, genres, categories or other aesthetic aspects for other kinds of vendor services, such as floral services, cuisine, and entertainment. Similarly, a process such as shown by an embodiment of FIG. 3 may be used to enable a person to specify information that manual or programmatic operators can use to develop for a theme, venue or other aspect of the event.

As another example, during a first online session, a user views and rates 20 samples. The user's event profile 340 is updated accordingly. The EPM 140 (FIG. 1) or other programmatic component to recommend or select one or more vendors is based in part on feedback from only those samples of the first online session. During a second online session, the user continues to update the event profile 340 by viewing and providing more feedback on additional samples.

Progressive Online Planning of Events

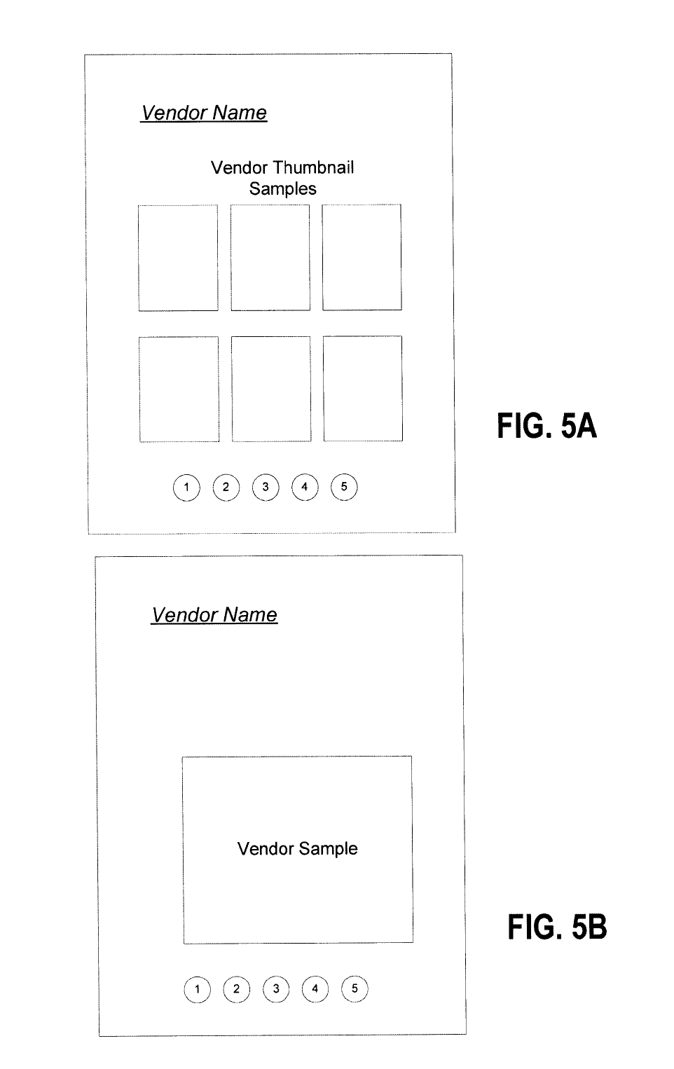

FIG. 4 describes a method for updating the event profile as information becomes known to a planner in stages, according to an embodiment of the invention. As will be described, an embodiment such as described with FIG. 4 and elsewhere enables a planner to progressively, sequentially, or gradually plan and coordinate an event, including the activities that are to occur in the event. Such a progressive approach enables the person to update a profile as information becomes known, or as an event planning comes closer to completion. As such, large events such as weddings can be efficiently planned, to accommodate tentative scheduling and planning that often takes place. Moreover, plans for such events can be modified and revised after initially being established, through similar processes.

According to one embodiment, a planner is electronically/programmatically assisted in planning an event with logistic information, vendor selection, and various other activities that may require coordination or advance planning. All the information about the event (e.g. actual date of the event, who will be attending, and vendors needed for the event) may not be known at a first instance when the user begins to plan for the event using a system such as provided by an embodiment. For example, the event may correspond to a wedding, and the persons planning an event may be the couple that is to be married. Initially, excitement may motivate the couple to initiate a planning session, even though no wedding site or date is known. At a first session the couple may enter all known information about the event such as the name of the bride and groom, anticipated vendors for the wedding, and a tentative guest list. During one or more subsequent sessions, the planners enter additional information that becomes known from a previous session. The planners may also change information previously provided. As described with various embodiments, during one or more of the sessions, profile information may be developed to facilitate the selection of one or more vendors for the event.

In an embodiment, once a user logs in to an online system (e.g. such as available through a website), the user is able to select a particular event dialogue from a web-based interface. The user is then able to input known information about the event, and this information is stored for the event profile. Information not yet known to the user may be entered at a later date, and the user does not have to re-enter the same information in a subsequent session. As such, the user does not need to know all information at once, but can arrive towards completion of the event planning in stages.

In step 402, after an event profile has been created, the user selects an event dialogue. The event dialogue provides any number of fields where information about the event may be entered. In one embodiment the event dialogue is a web form or other graphic user interface (GUI) that is web-enabled. The GUI allows a user to enter information which is subsequently stored in the event dialogue and may be updated or changed at a later online session.

There may be a number of event dialogues that serve various purposes in planning an event. In the case of a wedding event, for example, the dialogues may provide for one or more of the following: a user account dialogue in which information about the user is entered such as name, address, name of the bride and groom, account number, wedding date, email address, and other contact information; a help sheet that explains how to use the various dialogues; a schedule dialogue that explains information about the event such as start and end times of certain activities within an event; a question and answer dialogue that explains that the more information the system has about the event the better coverage for the event (e.g. in the case of a wedding, what photographs the bride and groom want, such as photographs with parents, grandparents, and friends, and what the bride and groom will be wearing); a vital statistics dialogue which provides logistic data for the event such as the number of guests and where the event will be held; a portrait worksheet dialogue, in instances where a photographer will be present at the event, this dialogue plans the photographs that will be taken at the event, who should be present for the photographs, and how much time is set aside for each photograph; an album preference dialogue which allows a user to select a style and layout of a photo album for photographs taken at the event; a DVD preference dialogue that may give the user the option to select a particular style of music for background music or songs that reflect the occasion (e.g. in the case of a wedding the bride and grooms “song”); photography consultant dialogue which shows samples of styles or even vendors; and a digital negatives dialogue where the user may view, select, and order selected photographs from an event. These dialogue enable planning of activities that may be needed before the event takes place, such as announcements and invitations, activities that take place during the event, and results or products derived from services and activities that occurred during the event. For example, hard copy products (DVD, album of images) may be specified as part of the planning user-interface experience.

According to one or more embodiments, each dialogue may be formatted so that it may be printed and distributed to a user and other participants of the event. In addition, each dialogue may be viewed by an administrator enabling them to view the progress of the event planning.

According to one or more embodiments, the dialogues individually relates to various aspects in planning an event. For example, if a user was planning a wedding and clicked on the user account dialogue, a GUI would appear on the screen and allow a user to input information relating to the wedding such as the date of the wedding, the name of the bride and groom, and contact information about the person creating the account. If the user then selected the schedule dialogue another GUI would appear that would allow the user to input information about the schedule of the actual wedding day, such as when the bride would arrive, when the groom would arrive, and at what time various photographs would be shot. Whenever event information is entered into one of the event dialogues, this information would be stored by the system. The information could be updated later in a subsequent session as planning for the event progressed into later stages of development, or when previously unknown information, such as the event date or location, is solidified.

In step 404, a determination is made as to whether a user has started the selected event dialogue. If the user has not started the selected event dialogue, a determination 422 is made as to whether the dialogue has not yet started or whether the dialogue is a future dialogue that is locked. If the dialogue is a future dialogue, step 424 does not allow a user to enter input. If however, the event dialogue has simply not been started, step 426 allows the user to enter input and step 428 stores and updates the dialogue for a subsequent session.

For example, the user may be precluded from filling out information for invitations until he has specified a location and a date. In this way, a dialogue, question or prompt that seeks information for sending out invitations may be blocked to the user until other dialogues deemed necessary for the invitations are first completed. Further in the case of a wedding, the user may be able to enter information about the wedding, such as the start time and end time of particular activities that are to take place during the wedding day. For example, these activities include the actual start and end time of the ceremony, the time the reception starts, the time of the cake cutting, the first dance etc.

If a determination is made in step 404 that the user has already started an event dialogue, a determination in step 406 is made to determine if the dialogue is complete or is a work in progress. If the determination in step 406 is that the event dialogue is in progress, step 408 displays the user progress in the event GUI. If more information is known about the event, then in step 410, the user is able to update or change the event information. The event information is then updated in step 420.

As another example, the user may log into an account and access the user account dialogue. From this dialogue, the user may enter the name of the bride and groom, but omit a wedding date or location. During a subsequent session, the user may select the user account dialogue and the information already entered by the user would be shown in the GUI. At that time, the user may then enter a finalized wedding date in the user account dialogue and the information would be stored. Once a date is known, other dialogues may be enabled. Alternatively, a condition for enabling other dialogues to be operable may be satisfied. For example, as described above, a dialogue for invitations may require both location and date to be entered, where both items of information are the conditions for the invitation dialogue.

However, if a determination is made in step 406 that the event dialogue is complete, step 412 displays to the user the event information. In step 414, a determination is made as to whether the dialogue is locked or unlocked. If the dialogue is locked 416, user event information is displayed to the user and no changes are allowed in the dialogue. If however, the dialogue is complete but unlocked, the user event information is displayed 418 and the information in the event dialogue is updated per user input 420.

For example, if the user is planning a wedding and has viewed and rated 100 out of 200 available sample photographs, and the designated defined number of photographs for viewing is 100, the event would be complete but not yet locked. On a subsequent session, the user may review the photographs that have been rated and may rate the additional 100 photograph samples. However, if the user then views and rates the remaining 100 photographs, the event dialogue would be complete and locked; the user would not be able to rate any more sample photographs pertaining to that event. Even so, the user may still be able to view the previously rated photographs.

Sample User Interfaces for Online System

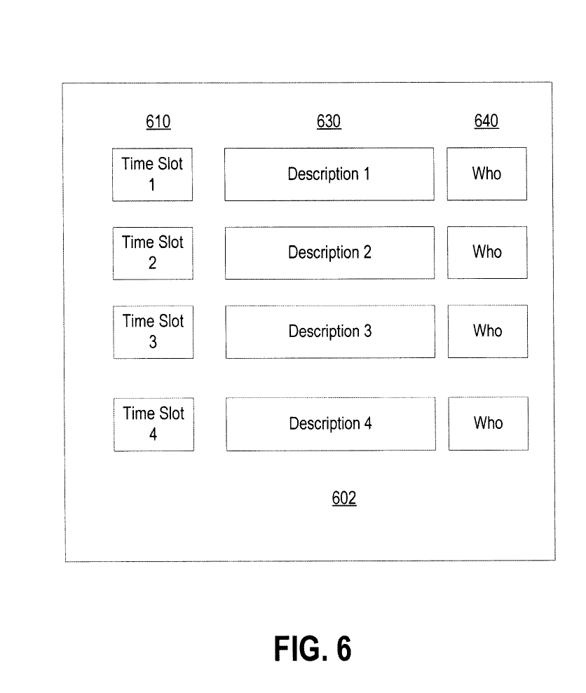

FIGS. 5A and 5B shows a sample user interface for rating samples according to an embodiment of the present invention. As mentioned, the samples may represent styles, categories, or even vendors, and enable a programmatic process where information about aesthetic preferences of the planners (or attendees) to be identified and accounted for in selection of services, vendors, and other aspects of event planning. In FIG. 5A, thumbnail images of vendor samples are presented to the user. The user may have an option to input a rating from 1-5 for all images contained on the page. All images contained in the thumbnail samples will receive the same score and the event profile will then be updated accordingly. Another series of thumbnail images may be presented to the user. If however, the user wishes to view the samples individually and rate each sample individually, the user may have the option to select one thumbnail image and rate that particular image. After the rating, another image is then presented to the user.

The thumbnail images in FIG. 5A may be organized or tagged to a particular style (genre, category vendor). For example, the system may group all samples of photographic styles into thumbnail images, giving the user a chance to rate all sample images simultaneously. Alternatively, referring to categories of photographs from above, the system may group together all category 1, 2, and 3 images and allow the user to rate thumbnail images grouped into categories.

In another embodiment, a user may be able to select one image from a thumbnail set and view and rate each individual sample image as described above and as shown in FIG. 5B. In either case, whether the samples are in thumbnail format or single view format, the user may view and rate all images and will then be presented with another sample.

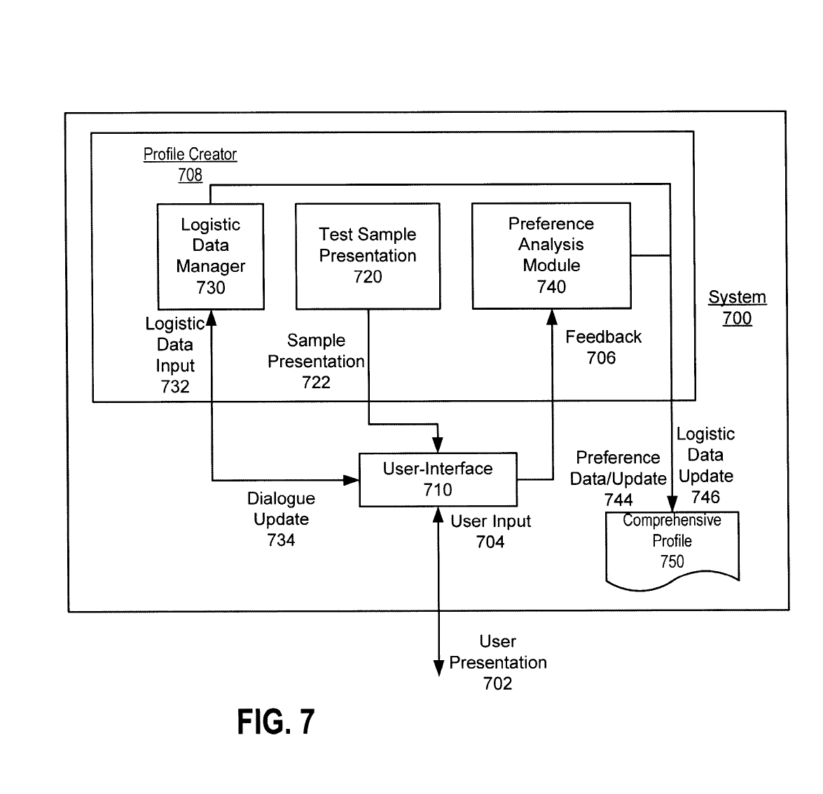

FIG. 6 shows an example of the schedule dialogue, according to an embodiment of the invention. The schedule dialogue 602 provides a programmatic event manager that allows a user to plan and view the actual day of the event. According to one or more embodiments, the schedule dialogue 602 provides another programmatic tool by which a comprehensive profile of the event may be formulated. The schedule dialogue 602 guides planners into providing information in an organized fashion, and the dialogue facilitates maintaining organization and structure in the planning process. Moreover, one or more embodiments contemplate that the dialogues can be shared with event participants, who can see plans for the event as they are updated, or alternatively provide information for use in planning or coordination. For example, attendees may specify whether they plan on attending, and whether they will bring guests.

In one implementation, the schedule dialogue 602 is an electronic user-interface, such as provided on an interactive web page. In addition, the schedule dialogue 602, or electronic/hard copy material derived from the schedule dialogue, may be shared with other participants (e.g. vendors and guests) of the event to enable coordination and planning by others. For example, vendors and guests may log on to a web site on which the schedule dialogue 602 is hosted.

According to an embodiment, the schedule dialogue 602 includes a plurality of scheduled time slot features 610 (e.g. beginning and end times), along with one or more various features of description. In an implementation shown by FIG. 6, a description feature 630 may describe an occurrence that is planned for the given time slot. In addition, a coordination feature 640 indicates guests or participants for the occurrence of the given time slot. In an implementation shown, the features correspond to text fields, although numerous other interactive features (e.g. menus, icons, check boxes) may be used. In a planned event, the time slot features may enable a planner to specify a start time and an end time. In one embodiment, the start and end times are shown by a GUI and the times may be changed by a scroll or pull down menu. A description of the event taking place at the specified time may be entered in the field 630 by the planner through, for example, text entry. The description informs participants of the event information about specific activities, including beginning and ending times, as well as what is to occur as part of the activity. Numerous other features and fields may be used to enable a user to communicate and plan the event, with the participation or involvement of other participants. The specific user-interface may even be configured by the user based on his or her preferences. In addition, as described with one or more other embodiments, the user may edit, update and change the schedule dialogue until the event becomes locked and all information regarding the event is stored to the event profile.

The following may provide an example of how an implementation such as shown by an embodiment of FIG. 6 may occur. In the case where the user is planning a wedding, and wishes to fill out certain activities of the wedding day, the bride may select the first event of the day to start at 11:00 AM and end at 12:00 PM. The description field 630 states that during this time the bride's pre-ceremony preparations are to take place. This description may be provided by either the bride or groom. The feature 640 may state that participants, such as the photographer, bride and bridesmaids, are to be in attendance for the stated activity. In a second row and other subsequent rows, the user may input various other activities that are to occur throughout the day. A second activity may begin at 12:00 PM and end at 1:00 PM. The description field 630 may state that the groom's pre-ceremony preparations are to begin and also contain information as to who attends (e.g. the groom, best man and photographer). As more activities in the event are finalized, the user may update the schedule. The information is stored in the event profile. In this manner, coordination of various occurrences in the event are noted and displayed. Scheduling and coordination may then take place either manually or through programmatic mechanisms.

System Architecture

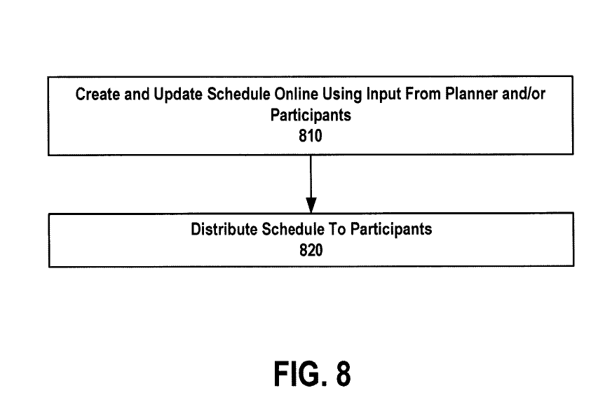

FIG. 7 illustrates a system architecture, under one or more embodiments of the invention. A system 700 may be provided on one or more systems that are accessible over the Internet, such as through a web site. In one embodiment, system 700 includes a profile creator 708 and a user-interface 710. The profile creator 708 includes different components that combine through various interactions with the user to create a comprehensive profile 750 of an event (e.g. wedding). As described elsewhere, profile 750 includes logistic data (e.g. location, date, invitation list, schedule of activities) and aesthetic preferences for one or more aspects or features of the event (e.g. vendor services).

In an embodiment, profile creator 710 includes a test sample presentation component 720, a logistic data manager 730, and a preference analysis module 740. The user interface 710 may include various types of user-interface features, including dialogues or other programmatic guides, by which the user can enter various kinds of input. The output of the user interface 710 includes presentation 702. Presentation 702 may be in the form of a web page that is downloaded to the user's terminal. Contents of the presentation 702 may include, for example, dialogues and sample sequences by which the user can provide feedback 706 (described below).

User-input 704 may include logistic data input 732, which is recorded and stored with the user's account by the logistic data manager 710. The logistic data manager 710 may provide signals or other prompts (dialogue update 734) by which various dialogues are updated to prompt the user to enter logistic information. As described with one or more other embodiments, the prompts to the user for logistic data may be staggered in time over more than one online session, in a manner that is conducive to the user's ability to plan for the event. As such, under on implementation, dialogue update 734 may correspond to a trigger where one dialogue is displayed to the user in response to the user completing another dialogue or satisfying another condition where another dialogue may be displayed.

The test sample presentation component 720 provides sample presentation 722 to the user to receive feedback 706. The samples may be provided as part of the presentation 702. The purpose of feedback 706 is to identify aesthetic preferences for use in profile 750. In one embodiment, test sample presentation component 720 is “dumb” and non-specific, meaning each user who uses the system 700 will receive the same sequence of samples. Alternatively, the sample presentation 722 may be specific or tailored to some information about the user (i.e. the planner), such as the user's location, age, or other information known about the user. Still further, the test sample presentation component 720 may be intelligent, in that individual components of the sample presentation 722 may conform to an on-the-fly learning process that the system 700 has in place where feedback 706 or event logistic data input 734 is used to select a next sample in the presentation 722.

The preference analysis module 740 receives feedback 706 and performs analysis operations to determine information that at least indicates an aesthetic preference of the user about some aspect of the event (e.g. vendor services). Under one or more embodiments, a method such as described with FIG. 2 or FIG. 3 may be implemented using the preference analysis module 740 and the test sample presentation 720. As mentioned with one or more embodiments, the feedback 706 may be in the form of rating input, or other quantitative input which can then be subjected to algorithms for determining stylistic preferences by category.

The profile 750 for any individual event may include logistic data 746 (as provided from logistic data manager 730 and/or the user) and feedback 706. Once the profile 750 is created, it may be used in various ways. For example, information from the profile 750 may be used to select vendors, services, décor and themes, are shared amongst individuals who are to plan and/or attend the event. In one embodiment, the profile 750 is used by human operators that then select or recommend vendors and other characteristics of the event. These operators may work in conjunction with interested parties that hold or participate in the event. Still further, some or all of the information of the profile 750 may be used by one or more programmatic processes that perform tasks such as vendor selection/recommendation.

As mentioned with one or more embodiments, the user may rate the system according the user's individual style preference, and the preference is recorded by the system as it relates to the vendor. In one implementation, once a predetermined number of samples have been rated by the user, the system recommends a vendor for the event to the user.

In an embodiment, a vendor may submit or remove a set of vendor samples to the system 700 via vendor interface 732. The result is that numerous samples are maintained for multiple vendors. For example, one vendor may only submit one sample, while another vendor may submit any number of samples to the system. In one embodiment, the vendor interface 732 is used to upload, edit, modify or create one or more samples from a given vendor. Furthermore, the vendor interface 732 may give the vendors 734 options to upload various samples to the database. For example, the vendor interface 732 may include fields for selecting the type of event the vendor caters to, and/or the style the vendor prefers. The photographer may also classify they type of work the photographer does, such as whether his photography style is more conservative or artistic. Fields or other user-interface features may be used to enable the vendors to make such classifications. As an example, in the case where the vendor is a live band or DJ, the vendor may submit a sample of their music. At the same time, the vendor may classify the type of event they cater for (e.g. weddings, anniversary parties, or receptions). The band or DJ may classify the type of music they play for the user, so as to identify, for example, a genre of the music to the user independent of the user listening to the music.

If the vendor samples are so classified, the database of vendor samples 730 may be organized according to various categories. The vendor database 730 may be arranged by type of event with sub-categories relating to vendors who commonly supply products or services to those types of events. The database may also have sub-categories that classify vendors according to vendor preference or style. For example, if an event planner knows they only like contemporary music at an event, the database will select those vendors who supply contemporary music. In this way, the event planner will only sample vendor products that more likely than not would have been selected by the event planner had the event planner sampled all vendors in a particular category.

In addition to feedback 706 and preferences, event information such as logistic data 750 may be used to make selections and identify vendors. In one embodiment, logistic data 750 enables a system to make an intelligent selection of vendor samples to present to an event planner. Based at least in part on the logistic data 750, the vendor recommendation/selection module 720 is able to select the vendors from the database 730 who provided samples that would normally provide services to the selected event. Based on the event, samples are sent from the database 730 to the user via the user interface 710. In this way the user is able to interact almost directly with many vendors by viewing a sampling of a number of vendor products.

Each time the user enters input to the user interface 710 as feedback 706, a preference rating or other running score associated with one or more vendors may be updated. As the preference rating is calculated, the list of potential vendors who may provide services to an event is narrowed. Once the list of potential vendors is built, a recommendation of a vendor may be made to the user or stored in the account.

For example, if a person is planning a wedding and looking for a photographer, each time the user rates a sample, the list of potential photographers may get smaller based on the overall score the user inputs as a result of liking or disliking particular categories of photographs. For instance, if the user continually gives photographs that fall within the traditional or conservative category of photographs a low score or rating, the likelihood that the system will recommend a photographer that focuses more on contemporary photographs will be lessened. Once the field of potential vendor for a particular service has been narrowed, the system will recommend a vendor and the user may either opt to use that vendor or the user may have the option to select another vendor.

In one embodiment, the system may recommend more than one vendor to provide a service for an event which enables a user more of a final say as to what vendor will provide the service.

Coordination

FIG. 8 illustrates a method in which event schedule information is created and distributed to various vendors and participants who will be at the event. The schedule information may be used to derive a master schedule that can be updated via a web interface and distributed to various participants. Under one embodiment, when the user has finalized the activities that will take place during the event, the schedule will be distributed to vendors and other participants who have been selected by the user to participate in the event.

In step 810 a schedule for the event is created or updated by one or more planners over a network such as the Internet. For example, a web site may host and execute a calendar application that can be run through the browser of the planner or other participant. In this way, the schedule may be created for the event based on information that may include, user specified information, including logistic data, the event profile, and the user profile. The schedule may include features and information that identifies events, vendors, and other information such as described with an embodiment of FIG. 6. The schedule may contain logistic data about the event, including start and end times for the event, start and end times for activities, vendor list, and guest list.

In one embodiment, a schedule is created through use of an online template that includes fields and features that the planner can select, modify and configure. Logistic data and other information may populate some of the fields.

In step 820, a schedule based on the schedule information is distributed or made available to various participants of the event. These participants may include vendors, guests and other individuals who may attend the event or have some association with the event. The distribution may be made through the Internet. For example, participants may log on to view the schedule, or the planner may send the schedule to users via electronic messaging. This distribution may occur either manually (e.g. printing out a schedule and sending or handing it to the vendor) or electronically via email or other form electronic messaging or communications.

For example, if a person is planning a wedding may have finalized a schedule of the wedding, the system may check the event profile to determine what vendors have been selected for the wedding. In the case of a photographer who has been selected for the event, the schedule will notify the photographer when and where the photographer must be present to take pictures of the wedding. If another vendor selected by the user is a caterer, the schedule may be electronically sent to the caterer to inform the caterer what time the luncheon or reception will start after the wedding and at what time the food should be prepared and ready.

Notification may also be sent to integral persons of the event. In the case of a wedding, the integral people of an event would be the bride and groom, the bridesmaids, the best man, and parents and family members of the bride and groom. If the bride wants a picture of herself and her bridesmaids taken at a certain time, the schedule will state at what time the photographer, bride, and bridesmaids should be at a particular location. The schedule will then either be manually delivered or electronically sent to the photographer, the bride and the bridesmaids.

### ALTERNATIVE EMBODIMENTS

While embodiments described above include creating a comprehensive profile that can be used for various activities, one or more embodiments further contemplate programmatic processes that use information in the profile to identify information for enabling or facilitating an event at various stages. In one embodiment, programmatic components may select or recommend vendors, décor, themes, and/or venues, based on profile 750. To this end, sample presentation 722 may represent both styles and vendors. Vendors may also have ability to access a system and provide samples for subsequent use by planners who use the system 700.

### CONCLUSION

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

What is claimed is:

1. A method for electronically assisting in planning events attended by persons, the method comprising:
receiving event information from a person planning an event; and
generating a profile for the event, wherein the profile includes information that indicates an aesthetic preference for one or more activities or services that are to be performed in connection with the event.

2. The method of claim 1, further comprising enabling distribution of the information through use of one or more computer-readable mediums to one or more individuals who plan or participate in the event.

3. The method of claim 1, wherein generating a profile for the event includes programmatically generating at least a portion of the profile.

4. The method of claim 1, wherein the profile includes logistic data that includes a time interval and/or location of the event.

5. The method of claim 1, wherein the aesthetic preference indicates a preference for a style of vendor services in connection with the event.

6. The method of claim 1, further comprising identifying, from the profile, one or more vendors for providing services in the event.

7. The method of claim 6, wherein identifying the one or more vendors includes recommending a candidate set of vendors from which the person planning the event can select from.

8. The method of claim 1, wherein receiving event information from a person planning an event includes receiving feedback, from a planner or participant of the event, in response to samples that represent the one or more activities or services.

9. The method of claim 8, wherein the feedback corresponds to a value that the planner or participant provides to each of the samples.

10. The method of claim 8, wherein receiving feedback includes displaying a plurality of samples to the planner or participants, and wherein the plurality of samples represent multiple genres or categories for a particular service or activity, and wherein generating a profile includes determining the genre or category that is preferred by the planner or participant from the feedback.

11. The method of claim 1, wherein the profile includes information that indicates an aesthetic preference for one or more vendors that are to provide services for the event.

12. The method of claim 1, wherein the profile includes information indicates an aesthetic preference for a venue of the event.

13. The method of claim 4, wherein logistic data includes data corresponding to one or more of (i) the number of persons attending the event, (ii) interested parties of the event, (iii) the date of the event, (iv) the address of the event, and (v) a time the event starts and ends.

14. The method of claim 3, wherein the profile includes one or more of (i) information identifying a person in charge of planning the event, (ii) names of at least some of the participants or attendees of the event, (iii) contact information of the person planning the event and/or of at least some of the participants or attendees of the event, and (iv) information identifying an account associated with the event.

15. The method of claim 1, wherein generating the profile includes receiving quantitative input from the user that rates one or more samples, and wherein the information indicating the aesthetic preference is based on analysis of the input.

16. The method of claim 1, wherein generating the profile includes receiving quantitative input from the user that ranks one or more samples, and wherein the information indicating the aesthetic preference is based on analysis of the input.

17. A method for electronically assisting in planning events attended by persons, the method comprising:
during a first online session, receiving event information from a person planning an event, wherein the event information corresponds to only a portion of the totality of the event information needed to assist in one or more of (i) coordinating the event or (ii) selecting vendors for the event;
during one or more subsequent online sessions, receiving a remaining portion of the totality of the event information; and
performing one or more programmatic actions for at least one of (i) coordinating the event or (ii) selecting vendors for the event.

18. The method of claim 18, wherein receiving event information during either the first or one or more subsequent online sessions corresponds to receiving input entered by the person in response to one or more prompts.

19. The method of claim 18, wherein the one or more prompts correspond to one or more electronic forms, and wherein receiving event information during either the first one or more subsequent online sessions corresponds to the person completing the one or more electronic forms during multiple sessions.

19. The method of claim 18, further comprising limiting portions of the one or more electronic forms for the person to complete until occurrence of one or more (i) a triggering event, or (ii) the person completing another portion of the one or more electronic forms.

20. The method of claim 16, wherein performing one or more programmatic actions includes (i) sending an electronic message, (ii) displaying information for coordinating the event on a web site, (iii) creating data for generating a hardcopy that includes information about the event.
